(19) United States
(12) Patent Application Publication
(10) Pub. No.: US 2006/0282455 A1
(43) Pub. Date: Dec. 14, 2006

(54) System and method for ranking web content

(75) Inventors: Hyun Chul Lee, Toronto (CA); Yingbo Miao, Toronto (CA)

Correspondence Address: BERESKIN AND PARR, 40 KING STREET WEST, BOX 401, TORONTO, ON, M5H 3Y2, CA

(73) Assignee: IT Interactive Services Inc., Halifax (CA)

(21) Appl. No.: 11/150,206

(22) Filed: Jun. 13, 2005

(51) Int. Cl. G06F 7/00

(52) U.S. Cl. 707/102

(57) ABSTRACT

A system and method for ranking Web content comprising Web pages or portions of Web pages containing a geographical entity are described. The system includes a data structure that comprises a graph representing the Web content. The graph includes a plurality of page nodes, wherein each page node represents one of the Web pages, a plurality of geographic nodes, wherein each geographic node represents one of the geographic entities, a plurality of directed page edges, wherein each directed page edge represents a directed link between a pair of Web pages, and a plurality of directed geographic edges, wherein each directed geographic edge represents a directed link between one geographic entity and one Web page. The system further includes a ranking module for ranking the Web content based on at least a portion of the plurality of directed page edges and a portion of the plurality of directed geographic edges.

### FIELD OF THE INVENTION

The present invention relates to Web content processing, and more particularly relates to systems and methods for ranking Web content.

### BACKGROUND OF THE INVENTION

The World Wide Web has become so large that the use of a search engine to find particular Web pages has become very popular. In a typical search engine, a user enters a search string into an appropriate field, and the search engine returns the uniform resource locators (URLs) of Web pages that contain a match. With the current size of the Web, it is not atypical for a search engine to find thousands of matches for a popular search string. With so many matches, it is not very useful to present to a user all of the Web pages found by the search engine in a random order. Rather, additional analysis of the Web pages is typically conducted to identify and present those pages that are most “relevant.”

For this purpose, Web page ranking methods are employed to convey to the user information about the relative importance of the Web pages. For example, a link analysis of the Web has been previously used to ascribe a rank to a Web page. In this approach, a Web page is given a higher rank if there are many other Web pages, or if there are few pages of very high rank, that point to it. The highest ranks are reserved for those Web pages that have many pages of very high rank that point to it.

However, the prior art methods do not always present the most relevant information for certain types of searching. For example, the prior art ranking methods do not always produce the most relevant results for searches seeking geographically related content.

Accordingly, there is a need for systems and methods for ranking Web content that incorporate geographic criteria.

### SUMMARY OF THE INVENTION

Described herein is a system and method for processing and ranking Web content that includes Web pages or portions of Web pages containing a geographical entity. As used herein, a geographical entity is any geographical information that represents a physical location of an entity. In one embodiment, a geographical entity may be an address that represents the physical location of an entity. According to a first aspect of the present invention, the method for ranking includes the step of representing the Web content as a graph. The graph includes: a) a plurality of page nodes, each page node representing one of the Web pages; b) a plurality of geographic nodes, each geographic node representing one of the geographic entities; c) a plurality of directed page edges, wherein each directed page edge connects a pair of page nodes and represents a directed link between a pair of Web pages represented by the pair of page nodes; and d) a plurality of directed geographic edges, wherein each directed geographic edge connects a geographic node and a page node and represents a directed link between one geographic entity represented by the geographic node and one Web page represented by the page node. The method for ranking also includes the step of ranking the Web content based on at least a portion of the plurality of directed page edges and a portion of the plurality of directed geographic edges.

According to a second aspect of the present invention, the system for ranking Web content, which includes Web pages or portions of Web pages containing a geographical entity, comprises a data structure including a graph representing the Web content. The graph includes: a) a plurality of page nodes, each page node representing one of the Web pages; b) a plurality of geographic nodes, each geographic node representing one of the geographic entities; c) a plurality of directed page edges, wherein each directed page edge connects a pair of page nodes and represents a directed link between a pair of Web pages represented by the pair of page nodes; and d) a plurality of directed geographic edges, wherein each directed geographic edge connects a geographic node and a page node and represents a directed link between one geographic entity represented by the geographic node and one Web page represented by the page node. The system also comprises a ranking module for ranking the Web content based on at least a portion of the plurality of directed page edges and a portion of the plurality of directed geographic edges of the graph.

According to a third aspect of the present invention, a computer readable medium having instructions for a computer for processing and ranking the Web content is provided. The medium includes instructions to cause the computer to perform the steps of: (i) representing the Web content as a graph having the elements described above; and (ii) ranking the Web content on at least the portion of the plurality of directed page edges and a portion of the plurality of the directed geographic edges of the graph.

### BRIEF DESCRIPTION OF THE DRAWINGS

FIG. 1 shows a block diagram of a system for parsing, storing, and ranking the Web content according to a first embodiment of the present invention, as well as a query engine for retrieval and display of a portion of the Web content based on the ranking.

FIG. 2 shows a graph of the type stored in the graph storage unit of FIG. 1.

FIG. 3A shows a block diagram of one embodiment of the ranking module of FIG. 1.

FIG. 3B is a flow diagram showing the calculation steps performed by the ranking module of FIG. 3A.

FIG. 4A shows another embodiment of the ranking module that employs a textual information measure.

FIG. 4B is a flow diagram showing the calculation steps performed by the ranking module of FIG. 4A.

FIG. 5 is a block diagram showing a more detailed view of the graph storage unit of the embodiment of FIG. 1, including the interaction of the graph storage unit with other components of the embodiment of FIG. 1.

### DETAILED DESCRIPTION OF THE PREFERRED EMBODIMENTS

Described herein is a preferred embodiment of a system and method for ranking Web content comprising Web pages or portions of Web pages containing a geographical entity. As used herein, a geographical entity is any geographical information that represents a physical location of an entity. In one embodiment, a geographical entity may be an address that represents the physical location of an entity. For example, in the United States, a geographical entity may be represented by a street number, a street name, a city name and a state name. Thus, a geographical entity may be represented by a set of tuples that consists of Street Number, Street Name, City Name, and State Name. In this representation, each tuple may be represented as an equivalence class. For example, Street Name can be an equivalence class containing the street names “First Street,” “First St.,” 1^{st} Street,” and 1^{st} St.” Likewise, City Name can be an equivalence class containing the city names “L.A.,” “LA,” and “Los Angeles.” Thus, the geographical entity “123 First Street, L.A., Calif.” is equivalent to “123 1^{st} St., Los Angeles, Calif.”

To obtain ranks of Web pages and geographical entities, several steps that precede the actual ranking may be executed. First, any suitable Web crawler (not shown) fetches Web pages from the Word Wide Web. Next, a geographic entity extractor parses the Web pages and the results are stored in one or more indexes. Finally, the ranking system accesses these indexes to rank Web pages and geographical entities. A description of the geographic entity extractor and the indexes along with their databases is provided below, but first, a ranking system and method are presented. Thus, for the nonce, it is assumed that a database of parsed Web content containing geographical entities already exists and is ready to be ranked.

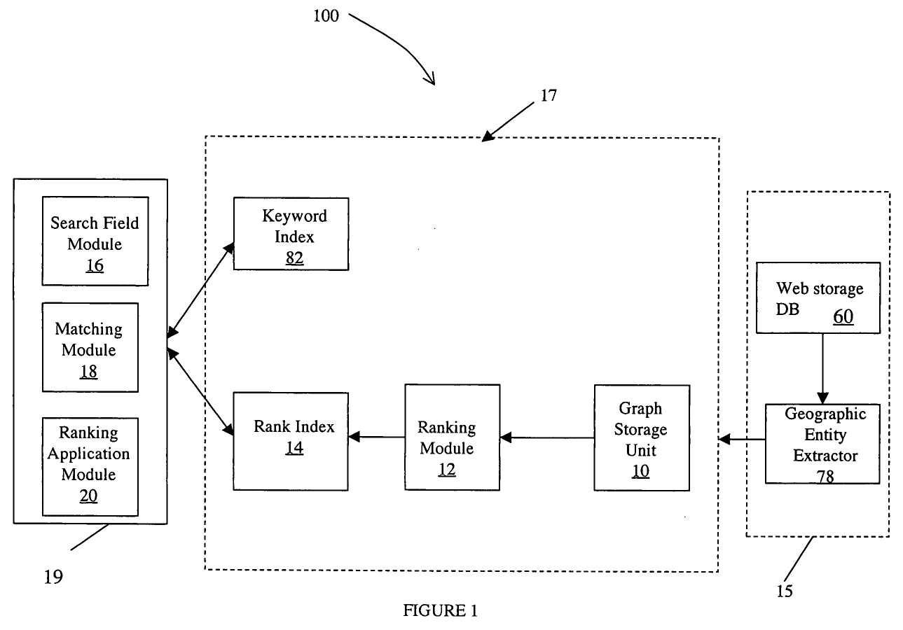

FIG. 1 shows a block diagram of a system 100 for ranking Web content comprising Web pages or portions of Web pages containing a geographical entity. The system 100 includes an input database system 15 which may comprise a Web storage database 60 and a geographic entity extractor 78. The system 100 also includes a rank and storage system 17 having a graph storage unit 10, a ranking module 12, a rank index 14, and a keyword index 82. The system 100 further includes a query engine 19 having a search field module 16, a matching module 18, and a ranking application module 20.

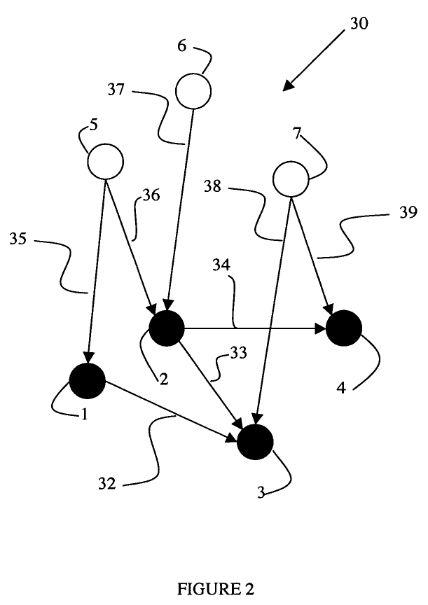

The input database system 15 stores data that is used in connection with ranking Web pages and geographic entities. In particular, the crawler (not shown) fetches and stores Web pages in the Web storage database 60 of the input database system 15 in preparation for ranking Web content comprising the Web pages or portions thereof containing a geographical entity. The rank and storage system 17 relies on the data produced from the input database system 15 to construct, in any suitable fashion, a data structure that includes a graph. The data structure that includes the graph is stored in the graph storage unit 10. The graph represents the Web content and is used by the ranking module 12 for ranking Web pages and geographic entities included in the Web content, as described in more detail below with reference to FIG. 2. The ranking data is stored in the rank index 14.

The search field module 16 inputs search field data entered by a user that may include geographically related information, such as a geographical location, and parses the information in preparation for further processing by the matching module 18. For example, the user can be prompted to enter search field data in the search field module 16 of the query engine 19, such as “What Chinese restaurants are located near Main Street and Willowdale Avenue in Halifax?”

The matching module 18 associates a set of Web pages, each containing at least one geographic entity, with the search field data. Preferably, each member of the set of Web pages contains 1) at least one geographic entity associated with the geographic location, and 2) a keyword, stored in the keyword index 82, that matches a word included in the search field data. For example, the matching module 18 can match the search field data of the previous example to a Web page containing a description of “Lee's Restaurant specializing in Chinese cuisine located at 123 Main St near Willowdale Ave in downtown Halifax.” The matching module 18 can find other such Web pages that contain a geographic entity associated with the geographic location entered by the user.

Each member of the set of Web pages is assigned a Web page rank, as determined by the ranking module 12. In addition, each member of the set includes at least one geographic entity, each of which is also assigned a rank determined by the ranking module 12. The ranking application module 20 utilizes the ranks of the Web pages and the ranks of the geographic entities to display to the user information contained in the set of Web pages. For example, in one application, only Web pages containing a geographic entity having a rank above a particular threshold are displayed in order of the Web page ranks. In another example, all of the matching Web pages may be presented to the user in order of their ranking.

FIG. 2 shows a graph 30 of the type stored in the graph storage unit 10 of FIG. 1. For simplicity, the graph 30 includes seven nodes 1-7. The nodes 1-4 are page nodes and the nodes 5-7 are geographic nodes. It should be understood that the number of nodes in the graph 30 are exemplary and that in a realistic application the number of nodes can number in the tens of millions or more. The page node 1 has one forward edge 32 to the page node 3. The page node 2 has two forward edges 33 and 34 to the page nodes 3 and 4 respectively. The page nodes 3 and 4 have no forward edges. The geographic node 5 has two forward edges 35 and 36 to page nodes 1 and 2 respectively. The geographic node 6 has a forward edge 37 to page node 2. The geographic node 7 has two forward edges 38 and 39 to page nodes 3 and 4, respectively. The edges are directed, meaning that an edge between a first node and a second node can be either a forward edge or a backward edge. If a first node has a forward edge to a second node, then the second node has a backward edge to the first node. Thus, the page node 4 has two backward edges, one to the page node 2 and one to the geographic node 7. In what follows, the node i is interchangeably referred to as the i^{th} node. Thus, page node 2 is also referred to as the second page node, and geographic node 7 is also referred to as the geographic seventh node. In addition, the i^{th} Web page refers to the Web page represented by the i^{th} page node.

The graph 30 represents the Web content. In particular, each page node represents one Web page, and each geographic node represents one geographic entity. A forward edge from page node k to page node i, denoted by k→i, represents a forward link from the k^{th} Web page to the i^{th} Web page. In other words, the k^{th} Web page includes a link to the i^{th} Web page. Likewise, a forward edge from the geographic j^{th} node to the s^{th} page node, denoted by j→s, represents a forward link between the geographic entity represented by the geographic j^{th} node and the s^{th} Web page. In other words, the s^{th} Web page contains the geographic entity represented by the geographic j^{th} node. There can only be a forward edge from a geographic node to a page node, since a geographic entity containing a Web page is meaningless. For example, in graph 30, the first and second Web pages each contain the same geographic entity represented by the geographic fifth node, which can be concisely written as 5→1 and 5→2.

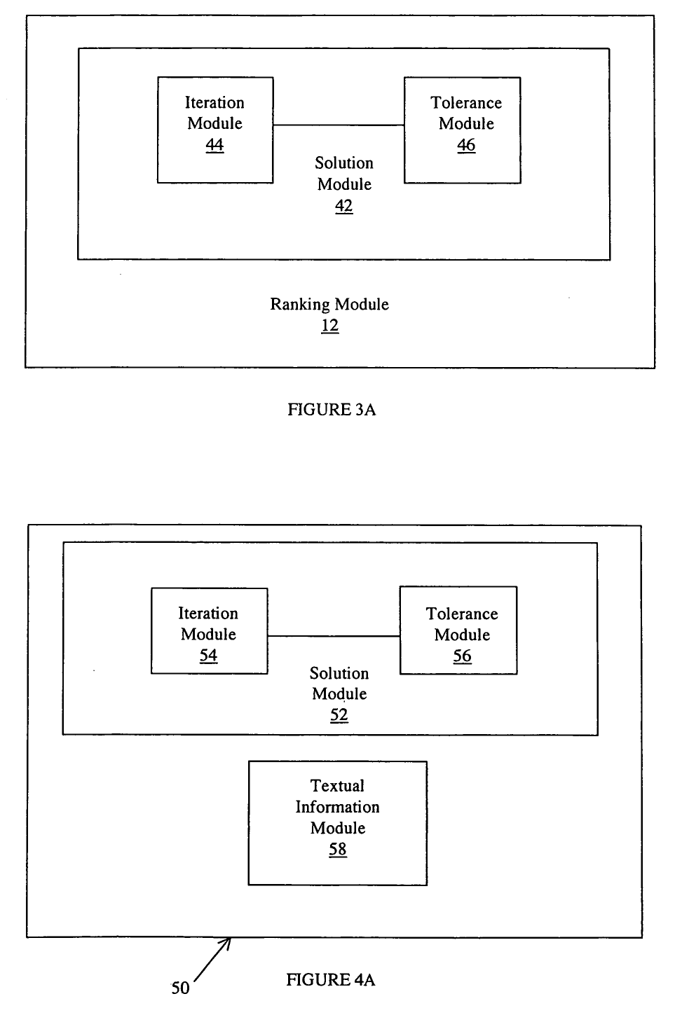

FIG. 3A shows the ranking module 12 of FIG. 1. The ranking module 12 includes a solution module 42 having an iteration module 44 and a tolerance module 46. FIG. 3B shows the calculation steps carried out by the ranking module 12 for approximately solving a pair of coupled relations, as described below, to obtain the rankings of the Web pages and the rankings of the geographic entities represented by the page nodes and the geographic nodes, respectively.

The calculation process begins at step 110. At step 112, the solution module 42 initializes the GR and PR vectors (described in detail below). At step 114, the iteration module 44 iteratively solves the coupled relations to obtain new values for the GR and PR vectors. At step 116, the tolerance module 46 determines, using a convergence tolerance test, whether the coupled relations have been approximately solved. If the convergence test fails, the process moves back to step 114. If the approximate solution of the GR and PR vectors calculated by the iteration module 44 passes the convergence tolerance test, the process ends at step 118.

The pair of coupled relations can be used to analyze a graph having n+m nodes, numbered from 1 to n+m, where nodes 1 to n are page nodes and nodes n+1 to n+m are geographic nodes. The graph 30 of FIG. 2, for example, has n=4 page nodes and m=3 geographic nodes. The pair of coupled relations relates a rank of page node i, PR(i), for i=1, . . . n, and the rank of geographic node j, GR(j), for j=n+1, . . . n+m, to the ranks of other page nodes and the ranks of other geographic nodes. In what follows, PR(i), for i=1, . . . n, is interchangeably referred to as the rank of page node i or the rank of Web page i, where the Web page i is the Web page represented by the page node i. Likewise, GR(j), for j=n+1, . . . n+m, is interchangeably referred to as the rank of geographic node j or the rank of the geographic entity represented by the geographic node j.

The pair of coupled relations for PR(i) and GR(j) are given by

$$\begin{matrix}PR ( i ) = \frac{ɛ}{n} + ( 1 - ɛ ) ( α {\sum }_{k : k \to i} \frac{PR ( k )}{F ( k )} + ( 1 - α ) {\sum }_{s : s ⇒ i} \frac{GR ( s )}{FR ( s )} ) & ( 1 ) \\ GR ( j ) = \frac{ɛ}{m} + ( 1 - ɛ ) {\sum }_{s : j ⇒ s} \frac{PR ( s )}{B ( s )} & ( 2 )\end{matrix}$$

where F(k) and B(k), for k=1, . . . ,n, are the number of forward and backward edges, respectively, at the k^{th} node, FR(s), for s=n+1, . . . , n+m, is the number of forward edges at the s^{th} node, ε and α are numbers that lie between zero and one, k→i, for k=1, . . . ,n and i=1, . . . ,n, indicates a forward edge from the k^{th} node to the i^{th} node, and j→s, for j=n+1, . . . ,m and s=1, . . . ,n, indicates a forward edge from the j^{th} node to the s^{th} node. The parameters α and ε can be any numbers greater than zero but less than one.

The model represented by Equations (1) and (2) recognizes that a high-ranking Web page is one to which many other high ranking pages point, and which contains many high ranking geographic entities. A high-ranking geographic entity, on the other hand, is one contained in many high-ranking pages. Equations (1) and (2) are coupled because Equation (1) for PR(i) depends on rankings of geographic entities, and Equation (2) for GR(j) depends on rankings of Web pages.

The solution module 42 converts Equations (1) and (2) to an equivalent vector representation given by
PR=εuₙ+(1−ε)(αA_{row}^{T}PR+(1−α)G_{row}^{T}GR) (3)
GR=εεuₘ+(1−ε)(G_{col}PR), (4)
where PR and GR are vectors, whose i^{th} components are PR(i) and GR(i), respectively. If A is the n×n adjacency matrix that represents the edge structure of the corresponding page node-to-page node sub-graph (i.e., the (i,j)-element is unity if the i^{th} Web page links to the j^{th} Web page, and zero otherwise), and G is the m×n adjacency matrix that represents the edge structure of the geographic node-to page node sub-graph (i.e., the (i,j)-element is unity if the j^{th} Web page contains the geographic entity represented by the geographic (n+i)^{th} node) then A_{row}, G_{row}, and G_{col} are the respective adjacency matrices obtained by row normalizing A, row normalizing G, and column normalizing G.

To approximately solve Equations (3) and (4), and consistent with the power iteration method known to those of ordinary skill in the art, the iteration module 44 iterates the following pair of equations
PR(^{(t+1)}=εuₙ+(1−ε)(αA_{row}^{T}PR^{(t)}+(1−α)G_{row}^{T}GR^{(t)}) (5)
GR^{(t+1)}=εuₘ+(1−ε)(G_{col}PR^{(t)}) (6)
using GR⁽⁰⁾, PR⁽⁰⁾ initialized to any unit-size vectors having non-zero elements to start the iteration. The iteration module 44 continues to iterate until the tolerance module 46 computes a norm of the vector difference |PR^{(t+1)}−PR^{(t)}| that is less than or equal to some particular tolerance 6. In one implementation, a row partition method is employed that partitions the relevant matrices into several row matrices and stores them as temporary files to leverage the memory burden.

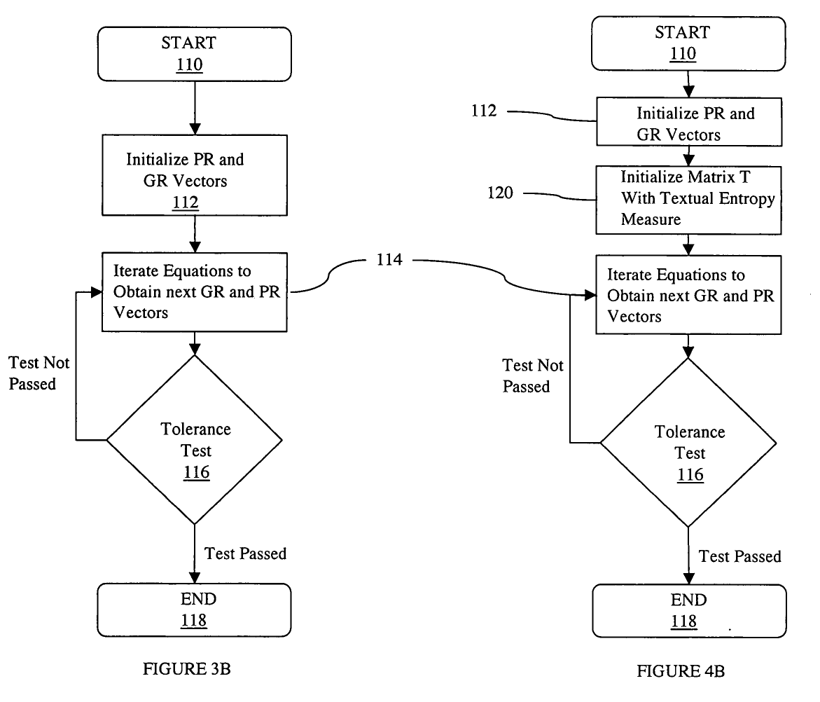

FIG. 4A shows another embodiment of the ranking module 50 that employs a textual information measure, in addition to a graph, to rank Web pages and geographic entities. The ranking module 50 in FIG. 4A includes a solution module 52 having an iteration module 54 and a tolerance module 56. The ranking module 50 further includes a textual information module 58. FIG. 4B shows the calculation steps carried out by the ranking module 50.

The calculation steps which are identical to those illustrated in FIG. 3B and described above have been assigned like reference numbers and will not be further described. The calculation steps of ranking module 50 includes the additional step 120 of initializing matrix T with the textual entropy measure (described in more detail below).

The textual information module 58 assigns a textual information measure to each one of the Web pages represented by a page node. The textual information measure of a Web page is based on the amount of textual information in the Web page relative to the amount of geographic entity information pertaining to all geographic entities in the Web page. The textual information measure is used by the iteration module 54 to approximately solve the pair of coupled relations.

The textual information measure is an entropy based measure which is used to assess the importance of a page based on the textual information therein. Intuitively, the more textual information associated with a geographical entity in a page, the higher the ranking of the page should be. The textual information measure of a Web Page is defined as the amount of textual information on the page relative to the amount of geographic entity information on the page.

1. To introduce the textual information measure, the hypertext mark-up language (HTML) representation of a Web page is first parsed by removing standard tags, extracting text, removing JavaScript lines, tokenizing the extracted text, and discarding internal links while preserving external links. A geographic entity s may be “tokenized” to yield the set s={s₁, . . . , sₖ}, where sⱼ is a word (such as “Main” in 123 Main St.) on the m^{th} Web page. The token-size of the geographic entity represented by the geographic s^{th} node, denoted by δ(s), is defined as the number of word-tokens, denoted δ(s)or |s|, comprising the geographic entity s. For example, the last set has δ(s)=k. Letting D(p) denote the number of word-tokens found on the Webpage p, the quantity h(s) is defined as

$$h ( s ) = 1 - \frac{δ ( s )}{D ( p )} \qquad ( 7 )$$

where p is the page at which s is found. The relative textual information measure T(p), is then given by

$$T ( p ) = {\sum }_{s ∈ p} h ( s ) \cdot log ( h ( s ) ) \qquad ( 8 )$$

The textual information measure may be employed in one of at least two ways to obtain a ranking of Web pages and geographic entities. First, the ranking module 50 can compute a final ranking of a Web page according to the expression
FR(p)=γPR(p)+(1−γ)T(p) (9)
where γ ε (0,1). Equation (9) is a weighted sum of the ranking of the page p, obtained through the graph analysis described above, and the textual information measure of the page p.

A second method of employing the textual information measure involves modifying the pair of coupled relations (1) and (2) to include the measure as follows

$$\begin{matrix}PR ( i ) = \frac{ɛ}{n} + ( 1 - ɛ ) ( α \cdot {\sum }_{k : k \to i} T ( k ) \cdot \frac{PR ( k )}{F ( k )} + ( 1 - α ) \cdot {\sum }_{s : s ⇒ i} \frac{GR ( s )}{FR ( s )} ) & ( 10 ) \\ GR ( j ) = \frac{ɛ}{m} + ( 1 - ɛ ) ( {\sum }_{s : j ⇒ s} T ( s ) \cdot \frac{PR ( s )}{B ( s )} & ( 11 )\end{matrix}$$

Equations (10) and (11) can be solved in the same manner that Equations (1) and (2) are solved. In particular, Equations (10) and (11) are converted to a vector representation by the solution module 52:
PR=ε·uₙ+(1−ε)·(α·A_{row}^{t}·T·PR+(1−α)·G_{row}^{t}·GR) (12)
GR=ε·uₘ+(1−ε)·(G_{col}·T·PR), (13)
where the i^{th} component of vector PR is PR(i), the j^{th} component of vector GR is GR(j), and T is an n×n diagonal matrix where the diagonal entries are the T(j).

To approximately solve Equations (12) and (13), and consistent with the power iteration method, the iteration module 54 iterates the following pair of equations
PR^{(t+1)}=ε·uₙ+(1−ε)·(α·A_{row}^{t}·T·PR^{(t)}+(1−α)·G_{row}^{t}·GR^{(t)}) (14)
GR^{(t+1)}=ε·uₘ+(1−ε)·(G_{col}·T·PR^{(t)}) (15)
with GR⁽⁰⁾, PR⁽⁰⁾ being initialized to any unit-size vectors having non-zero elements to start the iteration. The iteration module 54 continues to iterate until the tolerance module 56 computes a norm of the vector difference |PR^{(t+1)}−PR^{(t)}| that is less than or equal to some particular tolerance 6. One implementation employs a row partition method that partitions the relevant matrices into several row matrices and stores them as temporary files to leverage the memory burden.

The rankings of Web pages and geographic entities can be used for several purposes. In one application, the rankings are used to filter out Web pages that are matched in a Web search that have a ranking lower than some predetermined number. Thus, rankings below this number may not be displayed at all to a user performing a search. In another application, the rankings can be displayed to the user along with other information about the matched Web content. In yet another application, matched Web pages are displayed to a user in the order of their ranking.

In a preferred embodiment, the graph representing the Web content, which can include a large fraction of the World Wide Web (e.g., 100 million Web pages), and the rankings for the Web pages and geographic entities therein, are computed in advance of an actual search for a string entered by a user. The rankings can be stored in the rank index 14, to be accessed as needed when a search is performed.

In the above description of the system 100, it was assumed that a database of parsed Web pages containing geographical entities already existed and was ready to be ranked. In fact, to obtain ranks of Web pages and geographical entities, several steps that precede the actual ranking may be executed. First, a Web crawler, which can be any suitable crawler known to those of ordinary skill, fetches Web pages from the World Wide Web and stores the data into the Web storage database 60. Next, a geographic entity extractor 78 parses the Web pages by extracting keywords, link structure and geographic entities. The system 100 then stores the results into the graph storage unit 10 and keyword index 82. Finally, the ranking module 12 accesses the information in graph storage unit 10 to rank Web pages and geographic entities as explained above. Finally, the rank results are stored into the rank index 14. A description of the geographic entity extractor 78 and associated components of the rank/storage system 100 is now provided.

Geographic Entity Extractor

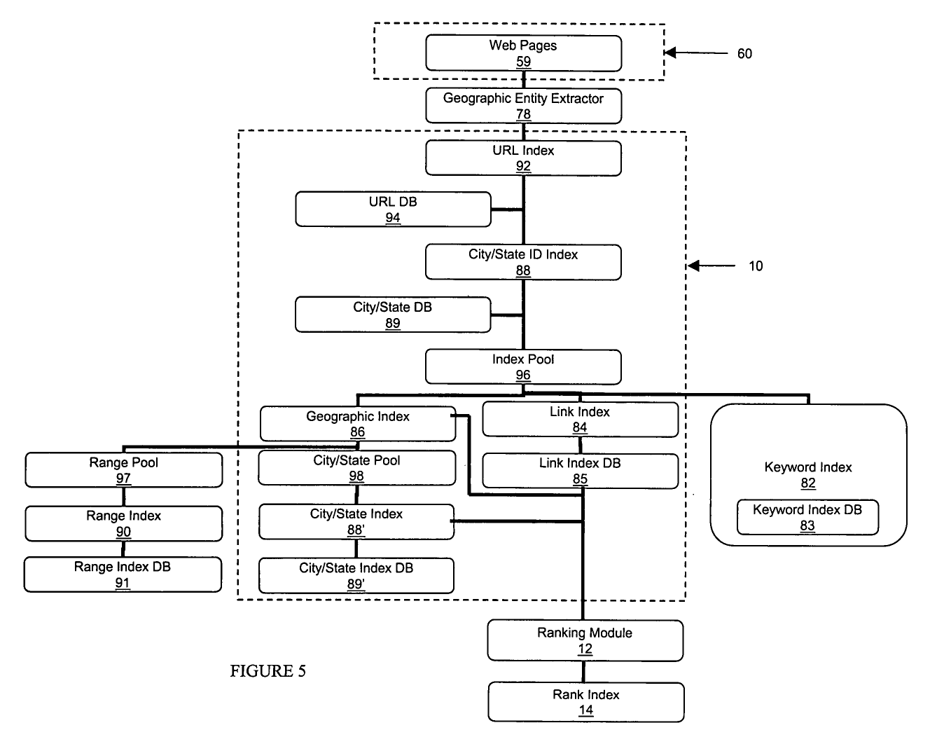

Referring now to FIGS. 1 and 5, a Web crawler (not shown) preferably fetches Web pages 59 from the World Wide Web and stores them in the Web storage database 60. The geographic entity extractor 78 parses the Web pages 59 and stores the resulting data in the graph storage unit 10 in preparation for building the graph, such as the graph 30 (shown in FIG. 2) for ranking.

The geographic entity extractor 78 identifies and extracts the geographic entities from the HTML pages of the Web content being analyzed. A typical geographical entity is found within a HTML page as the sequence number→streetname→cityname→statename; however, not all geographical entities are so represented.

A suitable geographical entity extractor 78 preferably deals with the following issues:

Ambiguity: How can one determine whether a sequence of tokens corresponds to the street name? For instance, in 1532 Howard Street New York, N.Y., clearly, Howard Street is a street name but in 1532 People died in New York, N.Y., “People died in” is not a street name. More ambiguous scenarios can arise, such as 1532 Howard New York N.Y. or 1532 34 Street New York N.Y. The main difficulty with ambiguity is that all possible lexical and semantic ambiguities cannot be anticipated, and therefore a manageable set of rules that successfully treats all cases is impossible.

Incomplete data: It is possible to find geographic entities without city name or state name or whose city name or state names are not found nearby. For instance, 1532 Howard Street is an instance of the former case while 1532 Howard Street in the city of New York is an instance of the latter case. A more difficult example of incomplete data is 1532 Howard.

The exemplary implementation of the geographical entity extractor 78 set out below addresses the problem of ambiguity and incomplete data. In addition to the extraction of geographical entities, the implementation of the geographical entity extractor 78 can extract text and links out of the HTML page, performing various tasks in one single pass through the HTML page. In particular, standard tags are removed, text is extracted, JavaScript lines are removed, extracted text is tokenized, and links are extracted (only the external links are tracked while the internal links are disregarded).

A set of gazetteers may be used for extraction. One such gazetteer contains a list of city names whose population is above 6000 residents along with its corresponding state name. The city name data may be collected from any suitable source, such as from the Website http://www.city-data.com. Another gazetteer that may be used contains the list of all possible street formats like avenue, highway, street, etc. along with the standard abbreviations. All street formats, city names and state names can be standardized after each geographical entity has been extracted.

Denoting by S={s₁, . . . ,sₖ}, the sequence of extracted tokens, two heuristics can be used to extract the geographic entities:

1. geographic entities with city name: In this case, the presence of a possible city name is used as a strong indication of possible geographical entity presence. The overall heuristic is the following:

```
for each sᵢ ∈ S do
    if sᵢ is city name then
        Check sᵢ₋ₗ,...,sᵢ₋ₘ is number.
        if sⱼ is number for some j then
            mark sⱼ as the street number
            Continue
        else if sⱼ is not address (e.g. sⱼ is stop word) for some j then
            Stop
        end if
        if no number is found then Stop
        Check sᵢ₋ₗ,...,sᵢ₊ₗ is state name
        if sⱼ is state name for some j then
            mark sⱼ as state name
            Continue
        else if sⱼ is not address (e.g. sⱼ is stop word) for some j then
            Stop
        end if
        Check sᵢ₋ₚ,...,sᵢ₊ₚ is zip code
        if sⱼ is zip code for some j then
            mark sⱼ as zip code
            Continue
        else if sⱼ is not address (e.g. sⱼ is stop word) for some j then
            Stop
        end if
    end if
end for
```

2. geographic entities without city name: In this case, the presence of a possible street format, such as street, avenue, highway, or boulevard is an indication of possible geographical entity presence. The overall heuristic is the following:

```
for each sᵢ ∈ S do
    if sᵢ is street format for some j then
        Check sᵢ₋ₗ,...,sᵢ₋ₘ is number.
        if sⱼ is number for some j then
            mark sⱼ as the street number
            Continue
        else if sⱼ is not address (e.g. sⱼ is stop word) for some j then
            Stop
        end if
        if no number is found then Stop
        Check sᵢ₋ₚ,...,sᵢ₊ₚ is zip code
        if sⱼ is zip code for some j then
            mark sⱼ as zip code
            Continue
        else if sⱼ is not address (e.g. sⱼ is stop word) for some j then
            Stop
        end if
    end if
end for
```

Once all possible geographic entities have been extracted according to the previously described heuristics, it may be necessary to determine what city name should be assigned to those geographic entities whose city name and state name are missing (as in case 2 discussed above). To complete this task, a maximum-likelihood method is employed by counting the number of city names found on the HTML page along with the population size of the city. The rationale behind this approach is that when the geographic entities are found without the city name, often the city name is mentioned elsewhere in the document, and usually it is the city name mentioned most often in the document. Moreover, this probability is closely related to the population size of the city, which reflects the intrinsic importance of the city in the Web. Therefore, the following formula may be derived:
P(city name|street number, street name)∝α·P(city name|document, state name)+(1−α)(city population) (16)
Therefore, the assigned city name is equal to
arg max{P(city name|street number, street name)}

There are many possible abbreviations for different street name formats. For instance, cen, ctr, cent, centr, centre are all possible abbreviations for center. Thus, each time a geographical entity is extracted, it is standardized so that all geographic entities can be represented by the same abbreviations

FIG. 5 shows the database structure of one embodiment of the present invention. After the Web crawler fetches the documents 59 from the Web and stores them in the Web storage database 60 of FIG. 1, and the geographic entity extractor 78 parses the corresponding documents, such as HTML pages, the geographic entity extractor 78 stores the parsed results in the various storage units shown in FIG. 5 (and described in more detail below) in an architecture that allows efficient data processing.

Indexes

FIG. 5 shows the keyword index 82, and an associated keyword index database 83, a link index 84, and associated link index database 85, the rank index 14, a geographic index 86, city/state indexes 88, 88′, and associated city/state index databases 89, 89′, a range query support index 90, and associated range query support index database 91, and a URL index 92, and associated URL index database 94. An index pool 96, a range pool 97, and a city/state pool 98 are also included.

The keyword index 82 is preferably used to retrieve those pages that contain a particular set of keywords that are supplied by a user in a search field. An inverted index approach may be employed. In such an approach, each unique word is used as the key and the value of a key is a list of documents (represented by their document IDs) containing the keyword along with its frequency. Additional information may also be stored in the keyword index, including weights, relative font sizes and position of a keyword within a Web document.

The link index 84 stores the graph structure (both nodes and edges) of the corresponding Web pages in the link database 85 of the graph storage unit 10. In one implementation, a forward link index, which uses the document ID as the key and all the documents being pointed to by the key document as its values, is utilized. In addition, an inverted link index, which uses the document ID as the key and its values as all the documents that point to the key document, is utilized.

An anchor index (not shown) stores anchor text of collected Web pages. Anchor text is a set of text around the hyperlink of a Web page, including the link itself. This anchor index may be employed by the ranking module 12 to complement its link based ranking with the anchor text information.

The geographic entity index 86 includes two sub-indexes, a forward geographical index and a backward geographical index. The key for the forward geography index is a document ID whose values are all geographic entities in the corresponding document, including the frequency at which the geographic entity is found within the document. The backward geographic index is the inverted version of the forward geographical index. It uses geographic entities as its keys and the documents that contain the key geographic entities as its values. A geographic entity typically includes an address that consists of a street number, a street name, a city name, and a state name. The zip code and longitude/latitude of an address is generated by a geocoder and are stored inside the geographic entity index 86.

The city/state indexes 88, 88′ support the retrieval of city name-city ID and state name-state ID. The key for city/state indexes 88, 88′ is the city/state ID and its values are all documents (represented by the document ID) that have at least one geographic entity within the scope of the city/state.

The range index 90 supports queries such as “Retrieve all documents which have at least one geographic entity within 5 miles of the specified address.” Some data structures, such as R-Tree, are able to support range search efficiently. To increase performance, the territory of the United States is partitioned into a rectangular grid, with each grid element having a predetermined area (such as a square having dimensions 5 miles by 5 miles). Each grid element is used as the key whose values are all documents corresponding to the geographical area corresponding to the grid element. Given an address and a radius, the grid element that corresponds to the address can be found. Thus, all Web pages having a geographical entity located in the grid element and nearby grid elements that are within a circle having the given radius can be obtained. The latitudes and longitudes are used as coordinates, and the divided grid elements are tagged by their distance from the origin. In this way, for each geographic entity, the corresponding grid element for the geographic entity may be easily obtained. The geographic entity extractor 78 parses Web pages and identifies geographic entities and outward links for each Web page, as described above. The extracted information and URLs are passed on to the city/state ID index 88 and the URL index 92.

The city/state ID indexes 88, 88′ generate a unique ID for each city/state, which is part of a geographic entity. The URL index 92 generates a unique ID for each URL. The extracted information is then saved in the index pool 96. The keyword index 82, the link index 84 and the geographic index 86, read data from the index pool 96 and store data in their respective databases 83, 85 and 87. The geographic index 86 also generates the range pool 97 and the city/state pool 98 for the range index 90 and for the city/state index 88′, respectively. Subsequently, the city/state index 88′ and the range index 90 read data from the city/state pool 98 and the range pool 97, respectively, and insert the data in their respective databases 89′ and 91.

The keyword index 82, the link index 84 and the geographic entity index 86 read data from the index pool 96 and insert the data into their own databases 83, 85 and 87. In addition, the geographic entity index 86 manages the pools 97 and 98 for the range support index 90 and the city/state index 88′.

Because of the high volume of data that is indexed, (e.g., more than 100,000,000 Web pages), an incremental inserting strategy for inserting data into the indexes is employed. Thus, the pools 96, 97, 98 are introduced to maintain the independence and integrity of data between different indexes used. Indexes or a set of indexes are inter-connected through the pools 96, 97, 98. Therefore, a change within an index is reflected in the corresponding pools and the other indexes can be easily revised by reading data back from these pools.

The use of pools 96, 97, 98 has several additional advantages. First, by using pools, the databases may be naturally divided into several parts making them independent of each other. Each part can have its own updating strategy and different numbers of threads. The parts can be deployed across different servers without affecting other parts of the system. Moreover, since each part communicates with pools, changes of interfaces of one part do not affect other parts.

There are two basic approaches that may be undertaken for pool management. First, a pool may be used as a log system, i.e., the pool stores sequentially all operations that are committed on the parent level. The indexes that read data from pools analyze their respective pool(s) to get correct information. Second, a pool may analyze data from the parent level. Thus, in this approach, more resources are spent on generating data for pools than for inserting data.

Because a search engine must process copious amounts of Web data, an efficient storage engine is advantageous. In particular, speed may be an important consideration for indexes that directly communicate with the query engine 19 (shown in FIG. 1). Moreover, the ranking system 100 according to the present invention preferably supports the storing of “BLOB” data, i.e. arbitrary length of binary data, since the type and length of data to be stored is not known ahead of time.

In one embodiment, the databases 83, 85, 89, 89′, 91 and 94, in addition to capable of high processing speed, may store any binary data as a key-value pair manner, and can support both B-tree and Hash indexes, association databases, catch, concurrent data storage and transactional data storage.

When the geographical entity extractor 78 inserts, deletes or updates one of the indexes shown in FIG. 5, the geographical entity extractor 78 connects to one or more databases at first, and subsequently disconnects from the one or more databases when all operations are terminated. Because the connecting and disconnecting operations are redundant when batch operations are performed, each index has interfaces for batch insertion, deletion and update.

In addition to incremental insertions, updating and deletion operations are also performed. While updates and deletions occur, all indexes are kept integrated while making them as independent as possible. Different parts that are divided up by pools have their own updating intervals and different numbers of threads.

A unique ID is assigned to each Web page of the Web content analyzed by the geographical entity extractor 78. The crawler, on the other hand, may use URLs to identify Web pages. Therefore, a mapping of a URL into the document ID is employed. In particular, to each URL, a unique ID is assigned. Given an ID, the corresponding URL may be retrieved. Similarly, a unique ID is assigned to the city or state name, which corresponds to the name of the city or the state. These assignments may be mathematically expressed as
f₁(S)=N and f₂(f₁(S))=S (17)
where S is a string and N is an unsigned number.

An ID index, which is a specialized version of the URL index 92 with an unsigned long type of N (i.e., N is a 32-bit integer representation without any sign), is used to manage the two functions f₁ and f₂. The city/state indexes 88, 88′ use unsigned integer-type of N since the number of cities or states is not expected to exceed 2¹⁶.

The query engine 19 (shown in FIG. 1) uses indexes to convert an ID to its corresponding name. A secondary index may be provided by building another database, whose key corresponds to the value of the main database. This technique is used to support f₂ in the last equation. The ID is recycled every time a string is deleted from the database since the list of IDs may be exhausted later. Thus, there is another database that stores all deleted IDs. These IDs are assigned to the newly inserted items.

The keyword index 82 is the largest index and utilizes a keyword index system library that is dynamically updatable, scalable (up to 1 Tb indexes), uses a controlled amount of memory, shares index files and memory cache among processes or threads and compresses index files to 50% of the raw data can be used. The structure of the index is configurable at runtime and allows inclusion of relevance ranking information.

To improve the overall performance of the databases shown in FIG. 5, a compression algorithm can be applied since all keys and values are stored as binary strings in the databases. The total amount of time that the compression algorithm spends on the compression and decompression should be less than the input/output time saved by using the compressed data.

It should be understood that the embodiments described above are exemplary only and that various modifications of the embodiments are contemplated by the inventors and fall within the scope of the invention whose limits are set by the following claims.

What is claimed is:

1. A system for ranking Web content, the Web content comprising Web pages or portions of Web pages containing a geographical entity, the system comprising:
a) a data structure comprising a graph representing the Web content, the graph comprising:
(i) a plurality of page nodes, wherein each page node represents one of the Web pages,
(ii) a plurality of geographic nodes, wherein each geographic node represents one of the geographic entities,
(iii) a plurality of directed page edges, wherein each directed page edge connects a pair of the page nodes, and
(iv) a plurality of directed geographic edges, wherein each directed geographic edge connects one of the geographic nodes and one of the page nodes; and
b) a ranking module for ranking the Web content based on at least a portion of the plurality of directed page edges and a portion of the plurality of directed geographic edges.

2. The system of claim 1, wherein the ranking module ranks the Web pages and the geographic entities included in the Web content.

3. The system of claim 1, further comprising:
a search field module for processing search field data entered by a user, the search field data including a geographical location;
a matching module for finding a match between the search field data and a set of Web pages included in the Web content, each member of the set of Web pages containing at least one geographic entity associated with the geographic location; and
a ranking application module for utilizing a rank of at least one Web page in the set of Web pages and a rank of the at least one geographic entity contained therein to display to the user information contained in the set of Web pages.

4. The system of claim 1, wherein the ranking module comprises a solution module for approximately solving a pair of coupled relations to rank the Web pages and to rank the geographic entities.

5. The system of claim 4, wherein the pair of coupled relations relates a rank of one Web page and a rank of one geographic entity to the ranks of other Web pages and the ranks of other geographic entities.

6. The system of claim 5, wherein the graph comprises n+m nodes, numbered from 1 to n+m, where nodes 1 to n are page nodes and nodes n+1 to n+m are geographic nodes, the pair of coupled relations being given by
$$\begin{matrix}PR ( i ) = \frac{ɛ}{n} + ( 1 - ɛ ) ( α {\sum }_{k : k \to i} \frac{PR ( k )}{F ( k )} + ( 1 - α ) {\sum }_{s : s ⇒ i} \frac{GR ( s )}{FR ( s )} ) \\ GR ( j ) = \frac{ɛ}{m} + ( 1 - ɛ ) {\sum }_{s : j ⇒ s} \frac{PR ( s )}{B ( s )}\end{matrix}$$
where PR(i), for i=1, . . . n, is the rank of the i^{th} node, GR(j), for j=n+1, . . . , n+m, is the rank of the j^{th} node, F(k) and B(k), for k=1, . . . ,n, are the number of forward and backward edges, respectively, at the k^{th} node, FR(s), for s=n+1, . . . , n+m, is the number of forward edges at the s^{th} node, ε and α are numbers that lie between zero and one, k→i, for k=1, . . . ,n and i=1, . . . ,n, indicates a forward edge from the k^{th} node to the i^{th} node, and j→s, for j=n+1, . . . ,m and s=1, . . . ,n, indicates a forward edge from the j^{th} node to the s^{th} node.

7. The system of claim 6, wherein the solution module comprises
an iteration module for iterating N times a vector representation of the coupled relations; and
a tolerance module that determines N by computing a convergence tolerance that indicates when the coupled relations have been approximately solved.

8. The system of claim 5, wherein the ranking module includes a textual information module for assigning a textual information measure to each one of the Web pages, the textual information measure of a Web page being based on an amount of textual information in the Web page relative to an amount of geographic entity information pertaining to all geographic entities in the Web page, wherein the textual information measure is used by the iteration module to approximately solve the pair of coupled relations.

9. The system of claim 8, such that the graph includes n+m nodes, numbered from 1 to n+m, where nodes 1 to n are page nodes and nodes n+1 to n+m are geographic nodes, wherein the textual information measure of node p, for p=1, . . . ,n, denoted by T(p), is given by
$$T ( p ) = {\sum }_{s ∈ p} h ( s ) \cdot log ( h ( s ) )$$
where
$$h ( s ) = 1 - \frac{δ ( s )}{D ( p )} ,$$
for s=n+1, . . . ,m, δ(s) is the number of word tokens in the geographic entity represented by node s, and D(p) is the number of word tokens in the Web page represented by node p.

10. The system of claim 9, wherein the pair of coupled relations are given by
$$\begin{matrix}PR ( i ) = \frac{ɛ}{n} + ( 1 - ɛ ) ( α \cdot {\sum }_{k \text{:} k \to i} T ( k ) \cdot \frac{PR ( k )}{F ( k )} + ( 1 - α ) {\sum }_{s : s ⇒ i} \frac{GR ( s )}{FR ( s )} \\ GR ( j ) = \frac{ɛ}{m} + ( 1 - ɛ ) {\sum }_{s : j ⇒ s} T ( s ) \cdot \frac{PR ( s )}{B ( s )}\end{matrix}$$
where PR(i), for i=1, . . . n, is the rank of the ith node, GR(j), for j=n+1, . . . , n+m, is the rank of the jth node, F(k) and B(k), for k=1, . . . ,n, are the number of forward and backward edges, respectively, at the kth node, FR(s), for s=n+1, . . . , n+m, is the number of forward links at the sth node, ε and α are numbers that lie between zero and one, k→i, for k=1, . . . ,n and i=1, . . . ,n, indicates a forward edge from the kth node to the ith node, and j→s, for j=n+1, . . . ,m and s=1, . . . ,n, indicates a forward edge from the jth node to the sth node.

11. A method of ranking Web content, the Web content comprising Web pages or portions of Web pages containing a geographical entity, the method comprising:
a) representing the Web content as a graph, the graph comprising:
(i) a plurality of page nodes, wherein each page node represents one of the Web pages,
(ii) a plurality of geographic nodes, wherein each geographic node represents one of the geographic entities,
(iii) a plurality of directed page edges, wherein each directed page edge connects a pair of the page nodes, and
(iv) a plurality of directed geographic edges, wherein each directed geographic edge connects one of the geographic nodes and one of the page nodes; and
b) ranking the Web content based on at least a portion of the plurality of directed page edges and a portion of the plurality of directed geographic edges.

12. The method of claim 11, wherein the step of ranking includes ranking the Web pages and ranking the geographic entities included in the Web content.

13. The method of claim 11, further comprising:
processing search field data entered by a user, the search field data including a geographical location;
finding a match between the search field data and a set of Web pages included in the Web content, each member of the set of Web pages containing at least one geographic entity associated with the geographic location; and
utilizing a rank of at least one Web page in the set of Web pages and a rank of the at least one geographic entity contained therein to display to the user information contained in the set of Web pages.

14. The method of claim 11, wherein the step of ranking includes approximately solving a pair of coupled relations to find ranks for the Web pages and ranks for the geographic entities.

15. The method of claim 14, wherein the pair of coupled relations relates a rank of one Web page and a rank of one geographic entity to the ranks of other Web pages and the ranks of other geographic entities.

16. The method of claim 15, such that the graph includes n+m nodes, numbered from 1 to n+m, where nodes 1 to n are page nodes and nodes n+1 to n+m are geographic nodes, the pair of coupled relations being given by
$$PR ( i ) = \frac{ɛ}{n} + ( 1 - ɛ ) ( α {\sum }_{k \text{:} k \to i} \frac{PR ( k )}{F ( k )} + ( 1 - α ) {\sum }_{s : s ⇒ i} \frac{GR ( s )}{FR ( s )} )$$
$$GR ( j ) = \frac{ɛ}{m} + ( 1 - ɛ ) {\sum }_{s : j ⇒ s} \frac{PR ( s )}{B ( s )}$$
where PR(i), for i=1, . . . n, is the rank of the ith node, GR(j), for j=n+1, . . . , n+m, is the rank of the jth node, F(k) and B(k), for k=1, . . . ,n, are the number of forward and backward edges, respectively, at the kth node, FR(s), for s=n+1, . . . , n+m, is the number of forward edges at the sth node, ε and α are numbers that lie between zero and one, k→i, for k=1, . . . ,n and i=1, . . . ,n, indicates a forward edge from the kth node to the ith node, and j→s, for j=n+1, . . . ,m and s=1, . . . ,n, indicates a forward edge from the jth node to the sth node.

17. The method of claim 16, wherein the step of ranking further includes iterating a vector representation of the coupled relations; and
computing a convergence tolerance that indicates when the coupled relations have been approximately solved.

18. The method of claim 15, wherein the step of ranking includes assigning a textual information measure to each one of the Web pages, the textual information measure of a Web page being based on an amount of textual information in the Web page relative to an amount of geographic entity information pertaining to all geographic entities in the Web page.

19. The method of claim 18, such that the graph includes n+m nodes, numbered from 1 to n+m, where nodes 1 to n are page nodes and nodes n+1 to n+m are geographic nodes, wherein the textual information measure of node p, for p=1, . . . ,n, denoted by T(p), is given by
$$T ( p ) = {\sum }_{s ∈ p} h ( s ) \cdot log ( h ( s ) )$$
where
$$h ( s ) = 1 - \frac{δ ( s )}{D ( p )} ,$$
for s=n+1, . . . ,m, δ(s) is the number of word tokens in the geographic entity represented by node s, and D(p) is the number of word tokens in the Web page represented by node p.

20. The method of claim 19, wherein the pair of coupled relations are given by
$$PR ( i ) = \frac{ɛ}{n} + ( 1 - ɛ ) ( α \cdot {\sum }_{k \text{:} k -> i} T ( k ) \cdot \frac{PR ( k )}{F ( k )} + ( 1 - α ) \cdot {\sum }_{s \text{:} s ⇒ i} \frac{GR ( s )}{FR ( s )} \\ GR ( j ) = \frac{ɛ}{m} + ( 1 - ɛ ) ( {\sum }_{s \text{:} j ⇒ s} T ( s ) \cdot \frac{PR ( s )}{B ( s )}$$
where PR(i), for i=1, . . . n, is the rank of the ith node, GR(j), for j=n+1, . . . , n+m, is the rank of the jth node, F(k) and B(k), for k=1, . . . ,n, are the number of forward and backward edges, respectively, at the kth node, FR(s), for s=n+1, . . . , n+m, is the number of forward links at the sth node, ε and α are numbers that lie between zero and one, k→i, for k=1, . . . ,n and i=1, . . . ,n, indicates a forward edge from the kth node to the ith node, and j→s, for j=n+1, . . . ,m and s=1, . . . ,n, indicates a forward edge from the jth node to the sth node.

21. A computer readable medium containing instructions for a computer for ranking Web content, the Web content comprising Web pages or portions of Web pages containing a geographical entity, the instructions causing the computer to perform the steps comprising:
a) representing the Web content as a graph, the graph comprising:
(i) a plurality of page nodes, wherein each page node represents one of the Web pages,
(ii) a plurality of geographic nodes, wherein each geographic node represents one of the geographic entities,
(iii) a plurality of directed page edges, wherein each directed page edge connects a pair of the page nodes, and
(iv) a plurality of directed geographic edges, wherein each directed geographic edge connects one of the geographic nodes and one of the page nodes; and
b) ranking the Web content based on at least a portion of the plurality of directed page edges and a portion of the plurality of directed geographic edges.
